(19) United States
(12) Patent Application Publication
(10) Pub. No.: US 2020/0102842 A1
(43) Pub. Date: Apr. 2, 2020

(54) TURBINE WHEEL ASSEMBLY WITH CERAMIC MATRIX COMPOSITE BLADES

(71) Applicants: Rolls-Royce Corporation, Indianapolis, IN (US); Rolls-Royce North American Technologies Inc., Indianapolis, IN (US)

(72) Inventors: Aaron D. Sippel, Zionsville, IN (US); Ted J. Freeman, Danville, IN (US)

(21) Appl. No.: 16/143,987

(22) Filed: Sep. 27, 2018

(51) Int. Cl. F01D 5/28; F01D 5/30; F01D 25/00

(52) U.S. Cl. CPC F01D 5/284; F01D 5/3038; F01D 25/005; F05D 2300/6033; F05D 2260/30; F05D 2300/10; F05D 2240/30

(57) ABSTRACT

A turbine wheel assembly adapted for use in a gas turbine engine includes turbine blades made from ceramic matric composite materials. The turbine blades are mounted to a disk and anti-rotation features block movement of the turbine blades around a circumference of the disk.

### FIELD OF THE DISCLOSURE

The present disclosure relates generally to vane assemblies for gas turbine engines, and more specifically to vanes that comprise ceramic-containing materials.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. Some rotating wheel assemblies can include ceramic-containing components. Ceramic-containing components can be designed to withstand very high temperatures while also being lightweight. In view of the potential benefits of including ceramic-containing materials in rotating wheel assemblies, there is a need for further design development in this area.

### SUMMARY

A turbine wheel assembly adapted for rotation about a central axis within a gas turbine engine is provide in the present disclosure. The assembly may include a multi-piece disk made of metallic materials, a turbine blade made of ceramic matrix composite materials, and an anti-rotation feature configured to block movement of the turbine blade relative to the multi-piece disk about the central axis.

In illustrated embodiments, the multi-piece disk may include a forward drum and an aft drum. Each of the forward drum and the aft drum may have a hub that extends around the central axis and a rim that provides a radially-outer portion of the multi-piece disk. The rim of the forward drum and the rim of the aft drum may be shaped to provide a radially-outwardly opening root channel that forms a dovetail shape when viewed circumferentially around the central axis.

In illustrated embodiments, the turbine blade may be shaped to include a root and an airfoil. The root may be arranged in the root channel of the multi-piece disk to couple the turbine blade to the multi-piece disk. The airfoil may be arranged radially outward of the multi-piece disk.

In illustrated embodiments, the anti-rotation feature may be arranged along a floor of the root channel of the multi-piece disk. In some embodiments, the anti-rotation feature is provided by a post integrated with another component or within a separate part. Various possible designs of the anti-rotation feature are provide herein but the features contemplated are not limited to those embodiments illustrated.

These and other features of the present disclosure will become more apparent from the following description of the illustrative embodiments.

### BRIEF DESCRIPTION OF THE DRAWINGS

FIG. 1 is a perspective view of a gas turbine engine with a portion of the engine cut away to show, from left to right, a turbofan, a compressor section, a combustor, and a turbine section included in the engine;

FIG. 2 is an elevation view of a turbine wheel assembly used in the turbine section of the engine of FIG. 1 showing that the turbine wheel assembly includes a multi-piece turbine disk and turbine blades spaced around the circumference of disk about a central axis;

FIG. 3 is a cross-sectional detail view of the turbine wheel assembly of FIG. 2 taken at line 3-3 showing that the turbine wheel assembly includes a multi-piece turbine disk comprising metallic materials, a turbine blade comprising ceramic matrix composite materials with a post-receiver pocket, and a post extending into the post-receiver pocket to provide an anti-rotation feature configured to block movement of the turbine blade relative to the multi-piece disk about the central axis;

FIG. 4 is an exploded view of the turbine wheel assembly of FIG. 3 showing that the turbine blade includes a root that forms a dovetail cross-sectional shape when viewed in the circumferential direction, that the multi-piece turbine disk includes a root channel extending circumferentially through the multi-piece turbine disk that receives the root of the turbine blade, and that the post is integral with the multi-piece disk;

FIG. 5 is a cross-sectional detail view of a second turbine wheel assembly showing that the turbine wheel assembly includes a multi-piece turbine disk comprising metallic materials, a turbine blade comprising ceramic matrix composite materials with a radially-inwardly-opening blind hole, and a pair of posts that provide an anti-rotation feature configured to block movement of the turbine blade relative to the multi-piece disk about the central axis;

FIG. 6 is an exploded view of the turbine wheel assembly of FIG. 5 showing that the turbine blade includes a root that forms a dovetail cross-sectional shape when viewed in the circumferential direction, that the multi-piece turbine disk includes a root channel extending circumferentially through the multi-piece turbine disk that receives the root of the turbine blade, and that the first post and the second post are each spaced equally apart and configured to be received in the radially-inwardly-opening blind hole formed in the turbine blade;

FIG. 7 cross-sectional detail view of the turbine blade and anti-rotation feature showing the posts within the post-receiver pockets in the root of the turbine blade;

FIG. 8 is a cross-sectional detail view of a third turbine wheel assembly showing that the turbine wheel assembly includes a multi-piece turbine disk comprising metallic materials, a turbine blade comprising ceramic matrix composite materials, and an independent component with a post that provides an anti-rotation feature configured to block movement of the turbine blade relative to the multi-piece disk about the central axis;

FIG. 9 is an exploded view of the turbine wheel assembly of FIG. 8 showing that the turbine blade includes a root that forms a dovetail cross-sectional shape when viewed in the circumferential direction, that the multi-piece turbine disk includes a root channel extending circumferentially through the multi-piece turbine disk that receives the root of the turbine blade, and the post is integrated with a mount pin extending into a pin-receiver hole and a shoulder at the interface of the post and the mount pin;

FIG. 10 is a cross-sectional detail view of a fourth turbine wheel assembly showing that the turbine wheel assembly includes a multi-piece turbine disk comprising metallic materials, a turbine blade comprising ceramic matrix composite materials, and a post integrated with the turbine blade to provide an anti-rotation feature configured to block movement of the turbine blade relative to the multi-piece disk about the central axis;

FIG. 11 is an exploded vie of the turbine wheel assembly of FIG. 10 showing that the turbine blade includes a root that forms a dovetail cross-sectional shape when viewed in the circumferential direction, that the multi-piece turbine disk includes a root channel extending circumferentially through the multi-piece turbine disk that receives the root of the turbine blade, and that the post that extends radially inward from the root of the blade into engagement with the multi-piece disk;

FIG. 12 is a cross-sectional detail view of a fifth turbine wheel assembly showing that the turbine wheel assembly includes a multi-piece turbine disk comprising metallic materials, a turbine blade comprising ceramic matrix composite materials, and a separable platform with an integrated post providing an anti-rotation feature configured to block movement of the turbine blade relative to the multi-piece disk about the central axis; and

FIG. 13 is an exploded vie of the turbine wheel assembly of FIG. 12 showing that the turbine blade includes a root that forms a dovetail cross-sectional shape when viewed in the circumferential direction, that the multi-piece turbine disk includes a root channel extending circumferentially through the multi-piece turbine disk that receives the root of the turbine blade, and that the post extends into engagement with the multi-piece disk.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

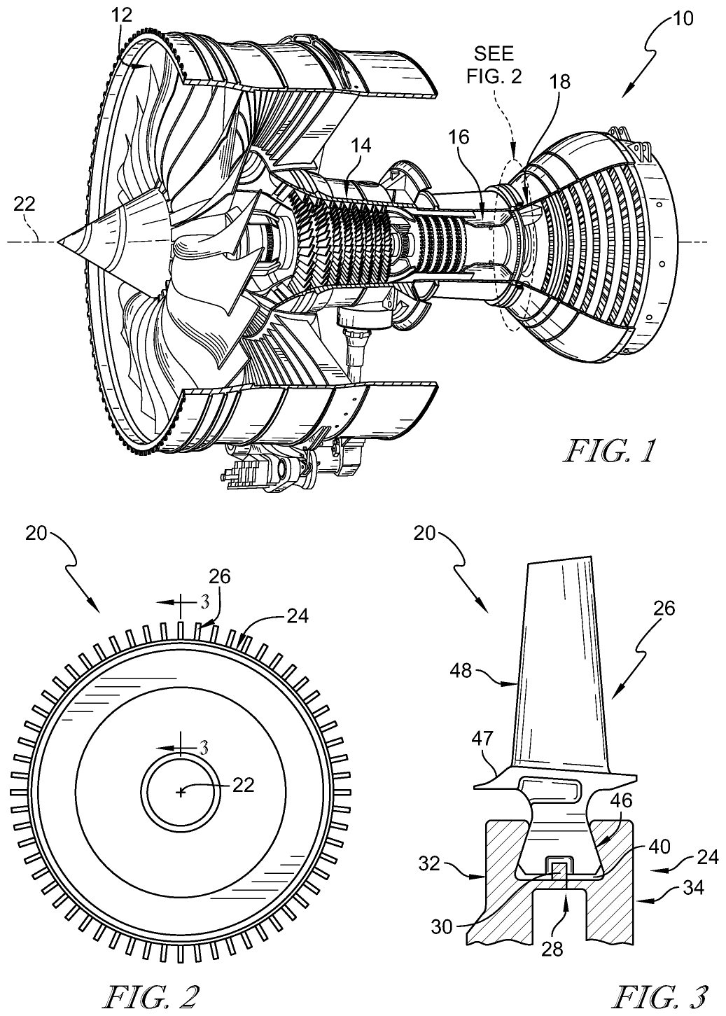

A turbine wheel assembly 20 according to the present disclosure is adapted for use in a gas turbine engine 10 as suggested in FIGS. 1-3. The engine 10 includes a turbofan 12, a compressor section 14, a combustor 16, and a turbine section 18 as shown in FIG. 1. The fan 12 rotates to provide thrust to an associated aircraft. The compressor section 14 draws in air and compresses it increasing pressure of the air before delivering it to the combustor 16. In the combustor 16, fuel is mixed with the pressurized air from the compressor section and is ignited to create hot high-pressure combustion products. The combustion products move out of the combustor 16 and into the turbine section 18 where they interact with the turbine section creating rotation of some turbine section 18 components that, in turn, drive rotation of the fan 12 as well as some components of the compressor section 14.

A first turbine wheel assembly 20 adapted for use in the turbine section 18 of the engine 10 is shown in FIGS. 2-4. The turbine wheel assembly 20 is designed to rotate about a central axis 22 upon interaction with expanding combustion products from the combustor 16. The turbine wheel assembly 20 includes a disk 24, a turbine blade 26, and an anti-rotation feature 28 as shown in FIG. 2. The disk 24 is illustratively multi-piece and is configured to rotate a shaft of the engine 10 about the central axis 22 during operation of the gas turbine engine 10. The turbine blade 26 is shaped to interact with and be rotated by the hot gases that expand as they move axially along a primary gas path of the gas turbine engine 10. The anti-rotation feature 28, illustratively a post 30, is configured to bock movement of the turbine blade 26 relative to the multi-piece disk 24 about the central axis 22.

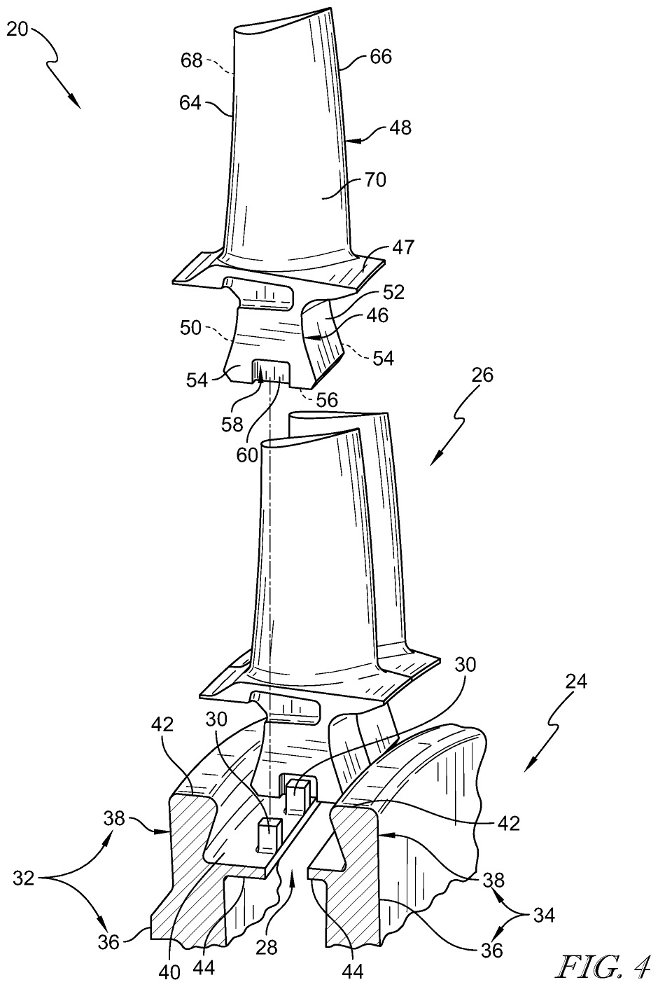

The multi-piece disk 24 made of metallic materials includes a forward drum 32 and an aft drum 34 as shown in FIGS. 3 and 4. The forward and aft drums 32, 34 are arranged around the central axis 22.

The forward drum 32 and the aft drum 34 each include a hub 36, a rim 38, and a root channel 40 as shown in FIGS. 3 and 4. The hub 36 extends around the central axis 22. The rim 38 provides a radially-outer portion of the multi-piece disk 24. The rim 38 of the forward drum 32 and the rim 38 of the aft drum 34 are shaped to provide a radially-outwardly opening root channel 40. The root channel 40 forms a dovetail shape when viewed circumferentially around the central axis 22 in the illustrative embodiment. In other embodiments, the root may have different shapes such as a fir tree shape of the like.

The rims 38 of the forward drum 32 and the aft drum 34 are shaped to include a retention ring 42 and a floor flange 44 as shown in FIGS. 3 and 4. The retention rings 42 extend around the central axis 22. The floor flanges 44 extend axially inward and away from the retention rings 42 relative to the central axis 22. Together, the retention rings 42 and the floor flanges 44 form the root channel 40. The retention rings 42 block axial movement of the turbine blade 26 while the floor 44 blocks radial inward movement of the blade 26. The retention rings 42 also help couple the blade 26 to the disk 24 and block radial outward movement of the blade 26 when the disk 24 rotates about the central axis 22.

The turbine blade 26 made of ceramic matrix composite materials includes a root 46 and an airfoil 48 as shown in FIGS. 3 and 4. The root 46 is arranged in the root channel 40 of the multi-piece disk 24 to couple the turbine blade 26 to the multi-piece disk 24 for rotation with the disk 24. The airfoil 48 extends radially away from the root 46 relative to the central axis 22. The airfoil 48 is shaped to be pushed circumferentially by the hot gases moving in the primary gas path to cause the turbine wheel assembly 20 to rotate about the central axis 22 during operation of the gas turbine engine 10.

The root 46 of the turbine blade 26 has a dovetail shape when viewed circumferentially about the central axis 22 as shown in FIG. 3. The root 46 includes a forward-root side 50 and an aft-root side 52 as shown in FIG. 4. The aft-root side 52 is spaced apart axially from the forward-root side 50. The forward-root and aft-root sides 50, 52 are positioned axially between the retention ring 42 of the rim 38 included in the disk 24 to located the root 46 in the root channel 40 and block axial movement of the root 46 in the root channel 40.

The root 46 of the turbine blade 26 further includes two circumferential sides 54 and a radially-inwardly facing side 56 as shown in FIGS. 3 and 4. The two circumferential sides 54 are circumferentially spaced apart and extend axially to the forward-root and aft-root sides 50, 52.

In the illustrative embodiment, the root 46 is shaped to define a post-receiver pocket 58 as shown in FIGS. 3 and 4. The post-receiver pocket 58 extends circumferentially into the circumferential side 54 of the root 46 so as to provide a circumferentially-opening aperture 60.

The airfoil 48 of the turbine blade 26 includes a leading edge 64 and a trailing edge 66 spaced apart axially from the leading edge 64 relative to the central axis 22 as shown in FIGS. 3 and 4. The airfoil 48 further includes a pressure side 68 and a suction side 70 spaced apart circumferentially from the pressure side 68 as shown in FIGS. 3 and 4. The pressure side 68 and the suction side 70 extend axially between and interconnect the leading edge 64 and the trailing edge 66.

The turbine blade 26 may further include a platform 47 as shown in FIGS. 3 and 4. The platform 47 is integrally formed with the airfoil 48 in the illustrative embodiment. The platform 47 extend circumferentially from the airfoil 48 to block hot gases interacting with a radially outer portion of the airfoil 48 form moving radially-inward toward the disk 24.

Illustratively, the root 46, the platforms 47, and airfoil 48 of each blade 26 are integrally formed such that each blade 26 is a one-piece integral component. The blade 26 comprises only ceramic matrix composite materials in the illustrative embodiment. In other embodiments, the blades 26 may comprise one or more of ceramic matrix composite materials, composite materials, and metallic materials. Due to the materials of the blades 26, the blades 26 may weigh less than similar sized fully-metallic blades.

The anti-rotation feature 28 arranged along the floor 44 of the root channel 40 includes a post 30 as shown in FIGS. 3 and 4. The post 30 extends radially outward from the floor 44 of the root channel 40. The post 30 engages the root 46 of the turbine blade 26 to block movement of the turbine blade 26 relative to the multi-piece disk 24 about the central axis 22.

In the illustrative embodiment, at least a portion of the post 30 extends into the post-receiver pocket 58 included in the root 46 of the turbine blade 26. The circumferentially-opening aperture provided by the post-receiver pocket 58 receives at least a portion of the post 30.

In the illustrative embodiment, at least a portion of the post 30 engages the post-receiver pocket 58 include in the root 46 of one turbine blade 26 and the other portion of the post 30 engages the root 46 of a neighboring turbine blade 26. In some embodiments, the anti-rotation feature 28 includes a plurality of posts 30 arranged circumferentially and equally spaced apart around the disk 24.

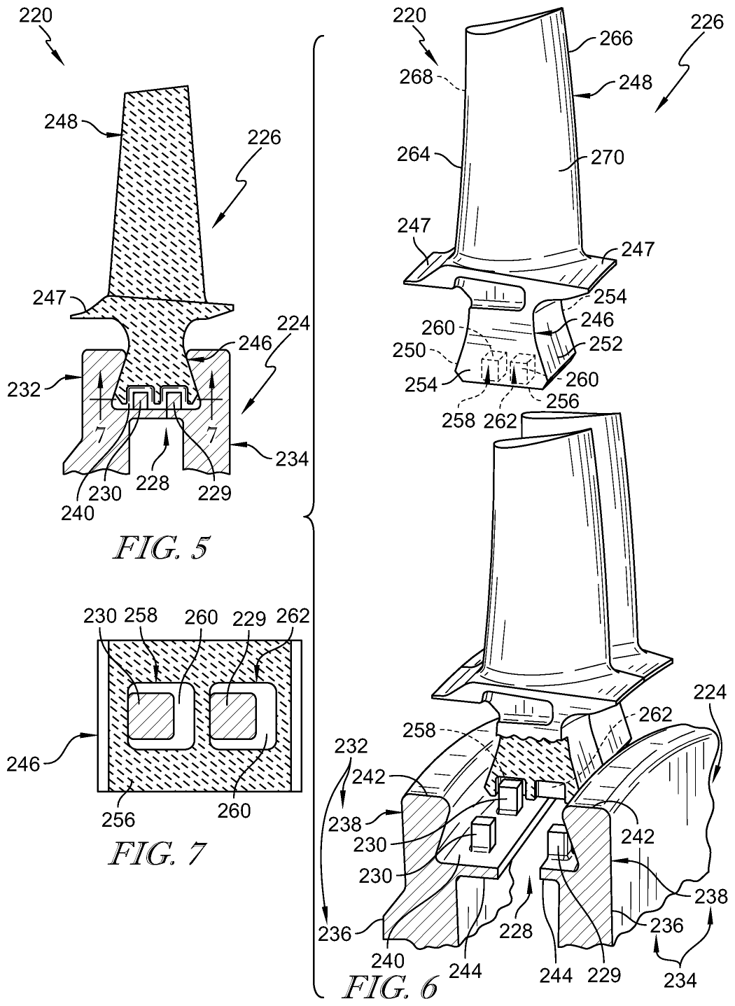

A second turbine wheel assembly 220 is shown in FIGS. 5-7 and is similar to the turbine wheel assembly 20 shown and described in FIGS. 3 and 4. The turbine wheel assembly 220 is designed to rotate about a central axis 22, upon interaction with expanding combustion products form the combustor 16. The turbine wheel assembly 220 includes a disk 224, a turbine blade 226, and an anti-rotation feature 228 as shown in FIG. 5. The disk 224 is illustratively multi-piece and is configured to rotate a shaft of the engine 10 about the central axis 22 during operation of the gas turbine engine 10. The turbine blade 226 is shaped to interact with and be rotated by the hot gases that expand as they move axially along a primary gas path of the gas turbine engine 10. The anti-rotation feature 228, illustratively a first post 229 and a second post 230, is configured to bock movement of the turbine blade 26 relative to the multi-piece disk 24 about the central axis 22.

The multi-piece disk 224 made of metallic materials includes a forward drum 232 and an aft drum 234 as shown in FIGS. 5 and 6. The forward and aft drums 232, 234 are arranged around the central axis 22.

The forward drum 232 and the aft drum 234 each include a hub 236, a rim 238, and a root channel 240 as shown in FIGS. 5 and 6. The hub 236 extends around the central axis 22. The rim 238 provides a radially-outer portion of the multi-piece disk 24. The rim 238 of the forward drum 232 and the rim 238 of the aft drum 234 are shaped to provide a radially-outwardly opening root channel 240. The root channel 240 forms a dovetail shape when viewed circumferentially around the central axis 22 in the illustrative embodiment. In other embodiments, the root may have different shapes such as a fir tree shape of the like.

The rims 238 of the forward drum 232 and the aft drum 234 are shaped to include a retention ring 242 and a floor flange 244 as shown in FIGS. 5 and 6. The retention rings 242 extend around the central axis 22. The floor flanges 244 extend axially inward and away from the retention rings 242 relative to the central axis 22. Together, the retention rings 242 and the floor flanges 244 form the root channel 240. The retention rings 242 block axial movement of the turbine blade 226 while the floor 244 blocks radial inward movement of the blade 226. The retention rings 242 also help couple the blade 226 to the disk 224 and block radial outward movement of the blade 226 when the disk 224 rotates about the central axis 22.

The turbine blade 226 made of ceramic matrix composite materials includes a root 246 and an airfoil 248 as shown in FIGS. 5 and 6. The root 246 is arranged in the root channel 240 of the multi-piece disk 224 to couple the turbine blade 226 to the multi-piece disk 224 for rotation with the disk 224. The airfoil 248 extends radially away from the root 246 relative to the central axis 22. The airfoil 248 is shaped to be pushed circumferentially by the hot gases moving in the primary gas path to cause the turbine wheel assembly 220 to rotate about the central axis 22 during operation of the gas turbine engine 10.

The root 246 of the turbine blade 226 has a dovetail shape when viewed circumferentially about the central axis 22 as shown in FIG. 3. The root 246 includes a forward-root side 250 and an aft-root side 252 as shown in FIG. 6. The aft-root side 252 is spaced apart axially from the forward-root side 250. The forward-root and aft-root sides 250, 252 are positioned axially between the retention ring 242 of the rim 238 included in the disk 224 to located the root 246 in the root channel 240 and block axial movement of the root 246 in the root channel 240.

The root 246 of the turbine blade 226 further includes two circumferential sides 254 and a radially-inwardly facing side 256 as shown in FIGS. 5 and 6. The two circumferential sides 254 are circumferentially spaced apart and extend axially to the forward-root and aft-root sides 250, 252.

In the illustrative embodiment, the root 246 is shaped to define a first post-receiver pocket 258 as shown in FIGS. 5-7. The first post-receiver pocket 258 extends radially outwardly into the radially-inwardly-facing side 256 of the root 246 between the two circumferential sides 254 of the root 246 as to provide a radially-inwardly-opening blind hole 260 that receives at least a portion of the post 229. In other embodiments, the first post-receiver pocket 258 extends circumferentially into the circumferential side 254 of the root 246 so as to provide a circumferentially-opening aperture.

In the illustrative embodiment, the root 246 is further shaped to define a second post-receiver pocket 262 as shown in FIGS. 5-7. The second post-receiver pocket 262 extends radially-outwardly into the radially-inwardly-facing side 256 of the root 246 between the two circumferential sides 254 of the root 246 as to provide a radially-inwardly-opening blind hole 260 that receives at least a portion of the post 230. In other embodiments, the second post-receiver pocket 262 extends circumferentially into the circumferential side 254 of the root 246 so as to provide a circumferentially-opening aperture. The first post-receiver pocket 258 and the second post-receiver pocket 262 are spaced apart from one another along the central axis 22 in the illustrative embodiment. In other embodiments, the first post-receiver pocket 258 and the second post-receiver pocket 262 are spaced apart from one another circumferentially with respect to the central axis 22.

In some embodiments, the

[symbol]

The airfoil 248 of the turbine blade 226 includes a leading edge 264 and a trailing edge 266 spaced apart axially from the leading edge 264 relative to the central axis 22 as shown in FIGS. 5 and 6. The airfoil 248 further includes a pressure side 268 and a suction side 270 spaced apart circumferentially from the pressure side 268 as shown in FIGS. 5 and 6. The pressure side 268 and the suction side 270 extend axially between and interconnect the leading edge 264 and the trailing edge 266.

The turbine blade 226 may further include a platform 247 as shown in FIGS. 5 and 6. The platform 247 is integrally formed with the airfoil 248 in the illustrative embodiment. The platform 247 extend circumferentially from the airfoil 248 to block hot gases interacting with a radially outer portion of the airfoil 248 form moving radially-inward toward the disk 224.

Illustratively, the root 246, the platforms 247, and airfoil 248 of each blade 226 are integrally formed such that each blade 226 is a one-piece integral component. The blade 226 comprises only ceramic matrix composite materials in the illustrative embodiment. In other embodiments, the blades 226 may comprise one or more of ceramic matrix composite materials, composite materials, and metallic materials. Due to the materials of the blades 226, the blades 226 may weigh less than similar sized fully-metallic blades.

The anti-rotation feature 228 arranged along the floor 244 of the root channel 240 includes a first post 229 as shown in FIGS. 5-7. The post 229 extends radially outward from the floor 244 of the root channel 240. The post 229 engages the root 246 of the turbine blade 226 to block movement of the turbine blade 226 relative to the multi-piece disk 224 about the central axis 222.

In the illustrative embodiment, at least a portion of the post 229 extends into the post-receiver pocket 258 included in the root 246 of the turbine blade 226. The radially-inwardly-opening blind hole 260 provided by the post-receiver pocket 258 receives at least a portion of the post 229. In other embodiments, the circumferentially-opening aperture provided by the post-receiver pocket 258 receives at least a portion of the post 229.

In the illustrative embodiment, the anti-rotation feature 228 further includes a second post 230 as shown in FIGS. 5-7. The post 230 extends radially outward from the floor 244 of the root channel 240. The post 230 engages the root 246 of the turbine blade 226 to block movement of the turbine blade 226 relative to the multi-piece disk 224 about the central axis 222.

In the illustrative embodiment, the second post 230 is spaced apart axially from the first post 229 along the central axis 22 as shown in FIG. 7. In other embodiments, the first post 229 and the second post 230 may be spaced apart circumferentially from one another with respect to the central axis.

In the illustrative embodiment, at least a portion of the post 230 extends into the post-receiver pocket 262 included in the root 246 of the turbine blade 226. The radially-inwardly-opening blind hole 260 provided by the post-receiver pocket 262 receives at least a portion of the post 230. In other embodiments, the circumferentially-opening aperture provided by the post-receiver pocket 262 receives at least a portion of the post 230.

In some embodiments, the anti-rotation feature 228 only includes one post 229, while the root 246 of the turbine blade 226 includes the first post-receiver pocket 258 and the second post-receiver pocket 262 spaced apart either axially or circumferentially. The first post-receiver pocket 258 receives a portion of the post 229, while second post-receiver pocket 262 acts as a lightening hole and removes material from the root of the blade to decrease the overall weight of the blade. The portion of material separating the first and second post-receiver pockets 258, 262 serves as a stiffening rib.

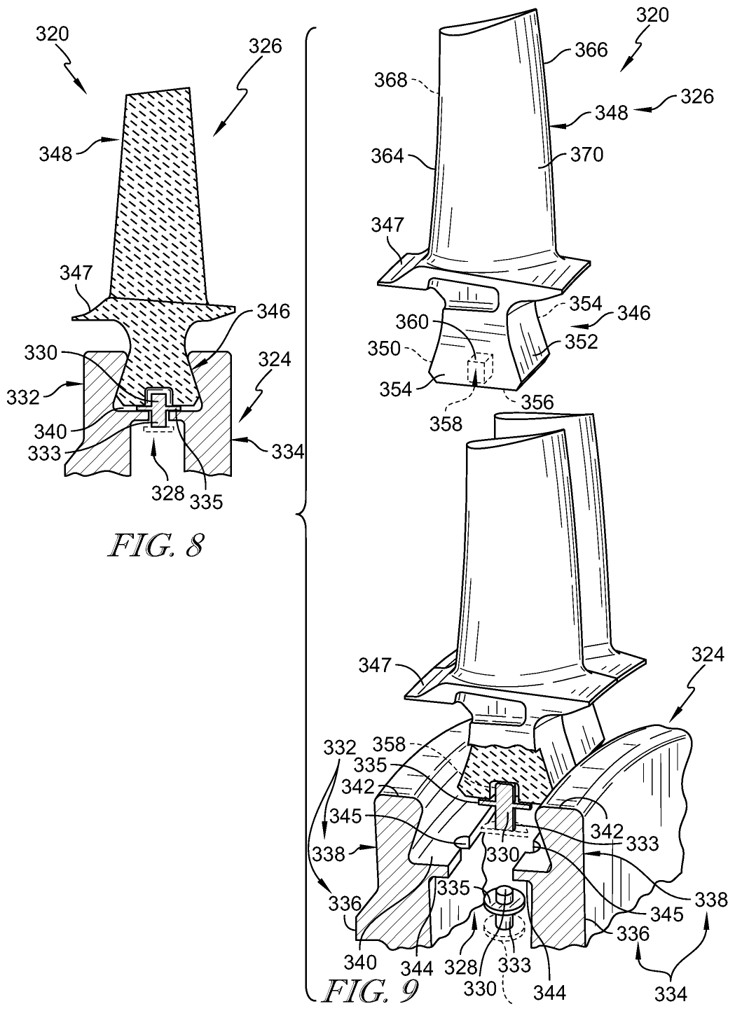

A third turbine wheel assembly 320 adapted for use in the turbine section 18 of the engine 10 is shown in FIGS. 8 and 9. The turbine wheel assembly 320 is designed to rotate about a central axis 22 upon interaction with expanding combustion products from the combustor 16. The turbine wheel assembly 320 includes a disk 324, a turbine blade 326, and an anti-rotation feature 328 as shown in FIG. 8. The disk 324 is illustratively multi-piece and is configured to rotate a shaft of the engine 10 about the central axis 22 during operation of the gas turbine engine 10. The turbine blade 326 is shaped to interact with and be rotated by the hot gases that expand as they move axially along a primary gas path of the gas turbine engine 10. The anti-rotation feature 328, illustratively a post 330 and a mount pin 331 that extends radially inwardly from the post 330, is configured to bock movement of the turbine blade 326 relative to the multi-piece disk 324 about the central axis 22.

The multi-piece disk 324 made of metallic materials includes a forward drum 332 and an aft drum 334 as shown in FIGS. 8 and 9. The forward and aft drums 332, 334 are arranged around the central axis 22.

The forward drum 332 and the aft drum 334 each include a hub 336, a rim 338, and a root channel 340 as shown in FIGS. 8 and 9. The hub 336 extends around the central axis 22. The rim 338 provides a radially-outer portion of the multi-piece disk 324. The rim 338 of the forward drum 332 and the rim 338 of the aft drum 334 are shaped to provide a radially-outwardly opening root channel 340. The root channel 340 forms a dovetail shape when viewed circumferentially around the central axis 22 in the illustrative embodiment. In other embodiments, the root may have different shapes such as a fir tree shape of the like.

The rims 338 of the forward drum 332 and the aft drum 334 are shaped to include a retention ring 342 and a floor flange 344 as shown in FIGS. 8 and 9. The retention rings 342 extend around the central axis 22. The floor flanges 344 extend axially inward and away from the retention rings 342 relative to the central axis 22. Together, the retention rings 342 and the floor flanges 344 form the root channel 340. The retention rings 342 block axial movement of the turbine blade 326 while the floor 344 blocks radial inward movement of the blade 326. The retention rings 342 also help couple the blade 326 to the disk 324 and block radial outward movement of the blade 326 when the disk 324 rotates about the central axis 22.

The floor flange 344 of the forward and aft drums 332, 334 is formed to include a pin-receiver hole 345 as shown in FIG. 9. The floor flange 344 of the forward drum 332 is shaped to form a first portion of the pin-receiver hole 345 and the aft drum is shaped to from a second portion of the pin-receiver hole 345 in the illustrative embodiment.

The turbine blade 326 made of ceramic matrix composite materials includes a root 346 and an airfoil 348 as shown in FIGS. 8 and 9. The root 346 is arranged in the root channel 340 of the multi-piece disk 324 to couple the turbine blade 326 to the multi-piece disk 324 for rotation with the disk 324. The airfoil 348 extends radially away from the root 346 relative to the central axis 22. The airfoil 348 is shaped to be pushed circumferentially by the hot gases moving in the primary gas path to cause the turbine wheel assembly 320 to rotate about the central axis 22 during operation of the gas turbine engine 10.

The root 346 of the turbine blade 326 has a dovetail shape when viewed circumferentially about the central axis 22 as shown in FIG. 8. The root 346 includes a forward-root side 350 and an aft-root side 352 as shown in FIG. 9. The aft-root side 352 is spaced apart axially from the forward-root side 350. The forward-root and aft-root sides 350, 352 are positioned axially between the retention ring 342 of the rim 338 included in the disk 324 to located the root 346 in the root channel 340 and block axial movement of the root 346 in the root channel 340.

The root 346 of the turbine blade 326 further includes two circumferential sides 354 and a radially-inwardly facing side 356 as shown in FIGS. 8 and 9. The two circumferential sides 354 are circumferentially spaced apart and extend axially to the forward-root and aft-root sides 350, 352.

In the illustrative embodiment, the root 346 is shaped to define a post-receiver pocket 358 as shown in FIGS. 8 and 9. The post-receiver pocket 358 extends radially outwardly into the radially-inwardly-facing side 356 of the root 346 between the two circumferential sides 354 of the root 346 as to provide a radially-inwardly-opening blind hole 360 that receives at least a portion of the post 230. In other embodiments, the first post-receiver pocket 358 extends circumferentially into the circumferential side 354 of the root 346 so as to provide a circumferentially-opening aperture.

The airfoil 348 of the turbine blade 326 includes a leading edge 364 and a trailing edge 366 spaced apart axially from the leading edge 364 relative to the central axis 22 as shown in FIGS. 8 and 9. The airfoil 348 further includes a pressure side 368 and a suction side 370 spaced apart circumferentially from the pressure side 368 as shown in FIGS. 8 and 9. The pressure side 368 and the suction side 370 extend axially between and interconnect the leading edge 364 and the trailing edge 366.

The turbine blade 326 may further include a platform 347 as shown in FIGS. 8 and 9. The platform 347 is integrally formed with the airfoil 348 in the illustrative embodiment. The platform 347 extend circumferentially from the airfoil 348 to block hot gases interacting with a radially outer portion of the airfoil 348 form moving radially-inward toward the disk 324.

Illustratively, the root 346, the platforms 347, and airfoil 348 of each blade 326 are integrally formed such that each blade 326 is a one-piece integral component. The blade 326 comprises only ceramic matrix composite materials in the illustrative embodiment. In other embodiments, the blades 326 may comprise one or more of ceramic matrix composite materials, composite materials, and metallic materials. Due to the materials of the blades 326, the blades 326 may weigh less than similar sized fully-metallic blades.

The anti-rotation feature 328 arranged along the floor 344 of the root channel 340 includes the post 330, the mount pin 331, and a shoulder 333 as shown in FIGS. 8 and 9. The mount pin 331 extends radially inwardly from the post 330 into the pin-receiver hold 345 in the floor 344 of the root channel 340. The post 330 engages the root 346 of the turbine blade 326 to block movement of the turbine blade 326 relative to the multi-piece disk 324 about the central axis 322. The shoulder 333 is located at the interface of the anti-rotation feature 328 and the floor 344 of the root channel 340 to block the anti-rotation feature 328 from moving through the pin-receiver hole 345.

In other embodiments, the anti-rotation feature 328 may include a first shoulder 333 and a second shoulder 335 as suggested in FIG. 9. The first shoulder 333 is located at the interface of the anti-rotation feature 328 and the floor 344 of the root channel 340 to block the anti-rotation feature 328 from moving through the pin-receiver hole 345. The second shoulder 335 is located at the interface of the anti-rotation feature 328 and a radially inwardly surface of the root channel 340 to block the anti-rotation feature 328 from further movement in the pin-receiver hole 345.

In the illustrative embodiment, at least a portion of the post 330 extends into the post-receiver pocket 358 included in the root 346 of the turbine blade 326. In other embodiments, the circumferentially-opening aperture provided by the post-receiver pocket 358 receives at least a portion of the post 330.

In the illustrative embodiment, at least a portion of the post 330 engages the post-receiver pocket 358 included in the root 346 of one turbine blade 326 and the other portion of the post 330 engages the root 346 of a neighboring turbine blade 326. In some embodiments, the anti-rotation feature 328 includes a plurality of posts 330 arranged circumferentially and equally spaced apart around the disk 324.

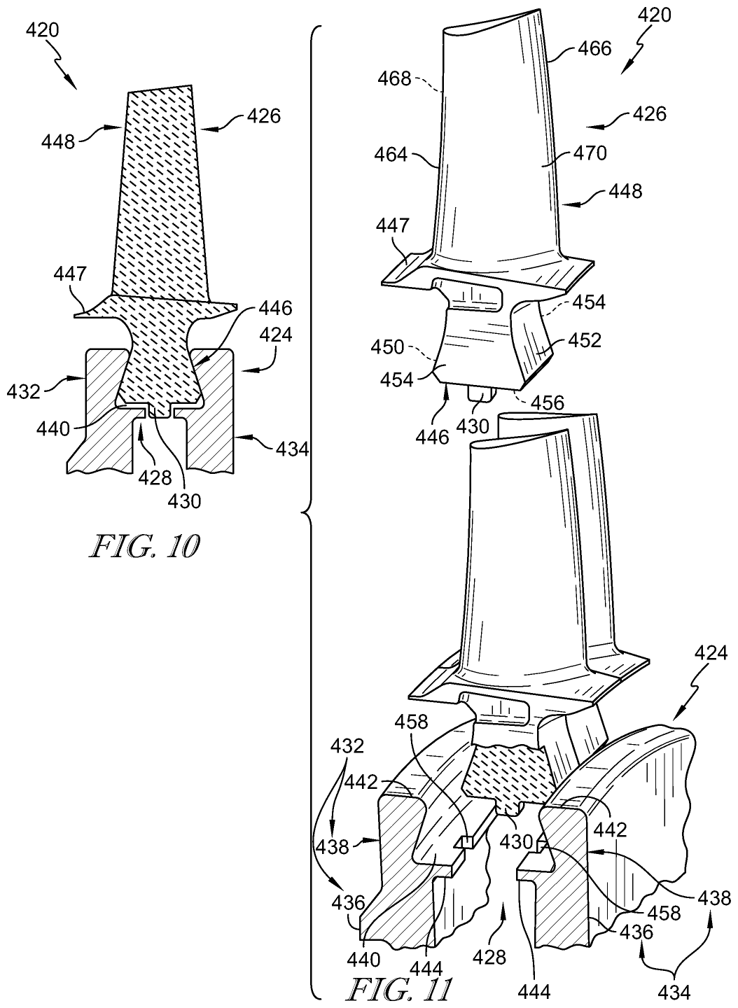

A fourth turbine wheel assembly 420 adapted for use in the turbine section 18 of the engine 10 is shown in FIGS. 10 and 11. The turbine wheel assembly 420 is designed to rotate about a central axis 22 upon interaction with expanding combustion products from the combustor 16. The turbine wheel assembly 420 includes a disk 424, a turbine blade 426, and an anti-rotation feature 428 as shown in FIG. 10. The disk 424 is illustratively multi-piece and is configured to rotate a shaft of the engine 10 about the central axis 22 during operation of the gas turbine engine 10. The turbine blade 426 is shaped to interact with and be rotated by the hot gases that expand as they move axially along a primary gas path of the gas turbine engine 10. The anti-rotation feature 428, illustratively a post 430, is configured to bock movement of the turbine blade 426 relative to the multi-piece disk 424 about the central axis 22.

The multi-piece disk 424 made of metallic materials includes a forward drum 432 and an aft drum 434 as shown in FIGS. 10 and 11. The forward and aft drums 432, 434 are arranged around the central axis 22.

The forward drum 432 and the aft drum 434 each include a hub 436, a rim 438, and a root channel 440 as shown in FIGS. 10 and 11. The hub 436 extends around the central axis 22. The rim 438 provides a radially-outer portion of the multi-piece disk 424. The rim 438 of the forward drum 432 and the rim 438 of the aft drum 434 are shaped to provide a radially-outwardly opening root channel 440. The root channel 440 forms a dovetail shape when viewed circumferentially around the central axis 22 in the illustrative embodiment. In other embodiments, the root may have different shapes such as a fir tree shape of the like.

The rims 438 of the forward drum 432 and the aft drum 434 are shaped to include a retention ring 442 and a floor flange 444 as shown in FIGS. 10 and 11. The retention rings 442 extend around the central axis 22. The floor flanges 444 extend axially inward and away from the retention rings 442 relative to the central axis 22. Together, the retention rings 442 and the floor flanges 444 form the root channel 440. The retention rings 442 block axial movement of the turbine blade 426 while the floor 444 blocks radial inward movement of the blade 426. The retention rings 442 also help couple the blade 426 to the disk 424 and block radial outward movement of the blade 426 when the disk 424 rotates about the central axis 22.

The floor flange 444 of the root channel 440 is formed to include a post-receiving pocket 258 as shown in FIG. 11. The floor flange 444 of the forward drum 432 is shaped to form a first portion of the post-receiving pocket 258 and the aft drum is shaped to from a second portion of the post-receiving pocket 258 in the illustrative embodiment.

The turbine blade 426 made of ceramic matrix composite materials includes a root 446 and an airfoil 448 as shown in FIGS. 10 and 11. The root 446 is arranged in the root channel 440 of the multi-piece disk 424 to couple the turbine blade 426 to the multi-piece disk 424 for rotation with the disk 424. The airfoil 448 extends radially away from the root 446 relative to the central axis 22. The airfoil 448 is shaped to be pushed circumferentially by the hot gases moving in the primary gas path to cause the turbine wheel assembly 420 to rotate about the central axis 22 during operation of the gas turbine engine 10.

The root 446 of the turbine blade 426 has a dovetail shape when viewed circumferentially about the central axis 22 as shown in FIG. 10. The root 446 includes a forward-root side 450 and an aft-root side 452 as shown in FIG. 11. The aft-root side 452 is spaced apart axially from the forward-root side 450. The forward-root and aft-root sides 450, 452 are positioned axially between the retention ring 442 of the rim 438 included in the disk 424 to located the root 446 in the root channel 440 and block axial movement of the root 446 in the root channel 440.

The root 446 of the turbine blade 426 further includes two circumferential sides 454 and a radially-inwardly facing side 456 as shown in FIGS. 10 and 11. The two circumferential sides 454 are circumferentially spaced apart and extend axially to the forward-root and aft-root sides 450, 452.

The airfoil 448 of the turbine blade 426 includes a leading edge 464 and a trailing edge 466 spaced apart axially from the leading edge 464 relative to the central axis 22 as shown in FIGS. 10 and 11. The airfoil 448 further includes a pressure side 468 and a suction side 470 spaced apart circumferentially from the pressure side 468 as shown in FIGS. 10 and 11. The pressure side 468 and the suction side 470 extend axially between and interconnect the leading edge 464 and the trailing edge 466.

The turbine blade 426 may further include a platform 447 as shown in FIGS. 10 and 11. The platform 447 is integrally formed with the airfoil 448 in the illustrative embodiment. The platform 447 extend circumferentially from the airfoil 448 to block hot gases interacting with a radially outer portion of the airfoil 448 form moving radially-inward toward the disk 424.

Illustratively, the root 446, the platforms 447, and airfoil 448 of each blade 426 are integrally formed such that each blade 426 is a one-piece integral component. The blade 426 comprises only ceramic matrix composite materials in the illustrative embodiment. In other embodiments, the blades 426 may comprise one or more of ceramic matrix composite materials, composite materials, and metallic materials. Due to the materials of the blades 426, the blades 426 may weigh less than similar sized fully-metallic blades.

The anti-rotation feature 428 arranged along the floor 444 of the root channel 440 includes a post 430 as shown in FIGS. 10 and 11. The post 430 extends radially inward from the radially-inwardly facing side 456 of the root of the turbine blade 426. The post 430 engages the floor 444 of the root channel 440 to block movement of the turbine blade 426 relative to the multi-piece disk 424 about the central axis 22. In the illustrative embodiment, at least a portion of the post 430 extends into the post-receiving pocket 458 included in the floor 444 of the root channel 440. In the illustrative embodiment, the post 430 is integrally formed from ceramic matrix composite materials along with the rest of the turbine blade 426 so as to comprise a one-piece component.

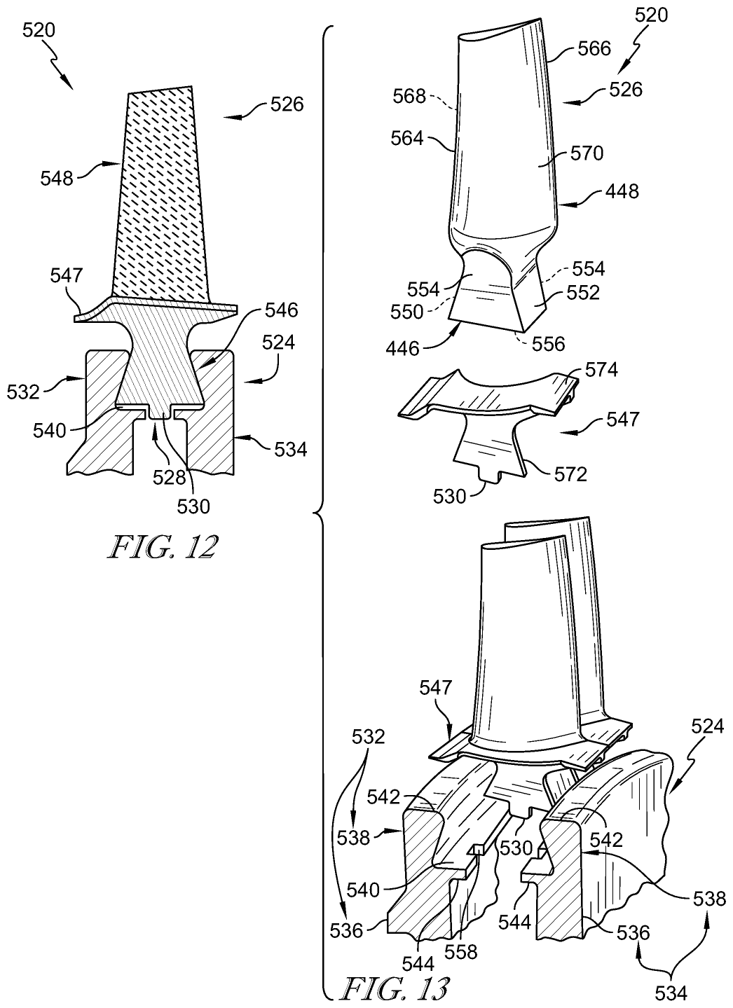

A fifth turbine wheel assembly 520 adapted for use in the turbine section 18 of the engine 10 is shown in FIGS. 12 and 13. The turbine wheel assembly 520 is designed to rotate about a central axis 22 upon interaction with expanding combustion products from the combustor 16. The turbine wheel assembly 520 includes a disk 524, a turbine blade 526, and an anti-rotation feature 528 as shown in FIG. 12. The disk 524 is illustratively multi-piece and is configured to rotate a shaft of the engine 10 about the central axis 22 during operation of the gas turbine engine 10. The turbine blade 526 is shaped to interact with and be rotated by the hot gases that expand as they move axially along a primary gas path of the gas turbine engine 10. The anti-rotation feature 528, illustratively a post 530, is configured to bock movement of the turbine blade 526 relative to the multi-piece disk 524 about the central axis 22.

The multi-piece disk 524 made of metallic materials includes a forward drum 532 and an aft drum 534 as shown in FIGS. 12 and 13. The forward and aft drums 532, 534 are arranged around the central axis 22.

The forward drum 532 and the aft drum 534 each include a hub 536, a rim 538, and a root channel 540 as shown in FIGS. 12 and 13. The hub 536 extends around the central axis 22. The rim 538 provides a radially-outer portion of the multi-piece disk 524. The rim 538 of the forward drum 532 and the rim 538 of the aft drum 534 are shaped to provide a radially-outwardly opening root channel 540. The root channel 540 forms a dovetail shape when viewed circumferentially around the central axis 22 in the illustrative embodiment. In other embodiments, the root may have different shapes such as a fir tree shape of the like.

The rims 538 of the forward drum 532 and the aft drum 534 are shaped to include a retention ring 542 and a floor flange 544 as shown in FIGS. 12 and 13. The retention rings 542 extend around the central axis 22. The floor flanges 544 extend axially inward and away from the retention rings 542 relative to the central axis 22. Together, the retention rings 542 and the floor flanges 544 form the root channel 540. The retention rings 542 block axial movement of the turbine blade 526 while the floor 544 blocks radial inward movement of the blade 526. The retention rings 542 also help couple the blade 526 to the disk 524 and block radial outward movement of the blade 526 when the disk 524 rotates about the central axis 22.

The floor flange 544 of the root channel 540 is formed to include a post-receiving pocket 558 as shown in FIG. 11. The floor flange 544 of the forward drum 532 is shaped to form a first portion of the post-receiving pocket 558 and the aft drum is shaped to from a second portion of the post-receiving pocket 558 in the illustrative embodiment.

The turbine blade 526 made of ceramic matrix composite materials includes a root 546, a platform 547, an airfoil 548 as shown in FIGS. 12 and 13. The root 546 is arranged in the root channel 540 of the multi-piece disk 524 to couple the turbine blade 526 to the multi-piece disk 524 for rotation with the disk 524. The platform 547 is independent of the turbine blade 526 and is located circumferentially adjacent to the turbine blade 526. The platform 547 is configured to separate a gas path along the airfoil 548 from the root of the turbine blade 526. The airfoil 548 extends radially away from the root 546 relative to the central axis 22. The airfoil 548 is shaped to be pushed circumferentially by the hot gases moving in the primary gas path to cause the turbine wheel assembly 520 to rotate about the central axis 22 during operation of the gas turbine engine 10.

The root 546 of the turbine blade 526 has a dovetail shape when viewed circumferentially about the central axis 22 as shown in FIG. 12. The root 546 includes a forward-root side 550 and an aft-root side 552 as shown in FIG. 13. The aft-root side 52 is spaced apart axially from the forward-root side 550. The forward-root and aft-root sides 550, 552 are positioned axially between the retention ring 542 of the rim 538 included in the disk 524 to located the root 546 in the root channel 540 and block axial movement of the root 546 in the root channel 540.

The root 546 of the turbine blade 526 further includes two circumferential sides 554 and a radially-inwardly facing side 556 as shown in FIGS. 12 and 13. The two circumferential sides 554 are circumferentially spaced apart and extend axially to the forward-root and aft-root sides 550, 552.

The platform 547 includes an attachment portion 572 and a gas path panel 574 as shown in FIGS. 12 and 13. The attachment portion 572 is arranged in the root channel 540 that is shaped to block movement of the platform 547 radially outwardly away from the multi-piece disk 524. The gas path panel 574 faces a gas path extending across the airfoil of the turbine.

The airfoil 548 of the turbine blade 526 includes a leading edge 564 and a trailing edge 566 spaced apart axially from the leading edge 564 relative to the central axis 22 as shown in FIGS. 12 and 13. The airfoil 548 further includes a pressure side 568 and a suction side 570 spaced apart circumferentially from the pressure side 568 as shown in FIGS. 12 and 13. The pressure side 568 and the suction side 570 extend axially between and interconnect the leading edge 564 and the trailing edge 566.

Illustratively, the root 546, the platforms 547, and airfoil 548 of each blade 526 are integrally formed such that each blade 526 is a one-piece integral component. The blade 526 comprises only ceramic matrix composite materials in the illustrative embodiment. In other embodiments, the blades 526 may comprise one or more of ceramic matrix composite materials, composite materials, and metallic materials. Due to the materials of the blades 526, the blades 526 may weigh less than similar sized fully-metallic blades.

The anti-rotation feature 528 arranged along the floor 544 of the root channel 540 includes a post 530 as shown in FIGS. 12 and 13. The post 530 extends radially inward from the radially inward from the attachment portion 572 of the platform 547. The post 530 engages the floor 544 of the root channel 540 to block movement of the turbine blade 526 relative to the multi-piece disk 524 about the central axis 22. In the illustrative embodiment, at least a portion of the post 530 extends into the post-receiving pocket 558 included in the floor 544 of the root channel 540. In the illustrative embodiment, the post 530 is integrally formed from ceramic matrix composite materials along with the rest of the platform 547 so as to comprise a one-piece component.

Ceramic matrix composite materials may be used in turbine blade applications. Ceramic matrix composite materials in the turbine blades results in the greatest benefits for implementing ceramic matrix composite components in gas turbine engines. In addition to the ceramic matrix composite materials being able to operate at higher temperatures, deliver cooling air savings, and reduce specific fuel consumption in the system, the weight reduction provided over a metallic blade system may be significant. The blades are lighter, but also the overall savings are multiplied since the size and weight of the disks will be reduced as well.

The turbine wheel assemblies 20, 220, 320, 420, 520 disclosed in this application may address the challenge of ways to anti-rotate ceramic matrix composite blade 26, 226, 326, 426, 526 circumferentially orientated and attached to a corresponding disc 24, 224, 324, 424, 524. Ceramic matrix composite components allow for the weight of the blades to be lower, but results in a decrease in strength. One of the ways to reduce the stress at the attachment of the blades is to flip the orientation of the attachment feature. Generally, attachments are orientated with the axis of the engine. However, flipping this general orientation from an axially orientation to a circumferential orientation or tangential, allows the attachment region to be larger and thicker which can effectively reduce stress applied to any one portion of the blades.

The circumferentially orientated blades of the present disclosure can be attached to a single disk incorporating a loading slot for attachment of the blades or a dual disk configuration. The platform features of the blades may also be removed from the blade component and instead the platforms could be offloaded platforms. The offloaded platforms remove the load applied to the blade attachment caused by the platforms.

The anti-rotation feature may be used to stop the blade from walking around the disk. Frictional forces resulting from the large loads acting on the blades are sufficient to stop the blade from sliding in the disks. However, an additional mechanical stop may be used to stop the rotation of the blades around the disk. The anti-rotation feature can include a single post or a number of posts interacting with the machined face of the ceramic matrix composite blade.

The blades may be assembled radially into the forward drum with the anti-rotation feature. Once all the blades are in position, the aft drum can then be driven into contact and coupled to the forward drum.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine wheel assembly adapted for rotation about a central axis within a gas turbine engine, the assembly comprising
a multi-piece disk made of metallic materials, the multi-piece disk including a forward drum and an aft drum, each of the forward drum and the aft drum having a hub that extends around the central axis and a rim that provides a radially-outer portion of the multi-piece disk, the rim of the forward drum and the rim of the aft drum shaped to provide a radially-outwardly opening root channel that forms a dovetail shape when viewed circumferentially around the central axis,
a turbine blade made of ceramic matrix composite materials, the turbine blade shaped to include a root arranged in the root channel of the multi-piece disk to couple the turbine blade to the multi-piece disk and an airfoil arranged radially outward of the multi-piece disk, and
an anti-rotation feature arranged along a floor of the root channel of the multi-piece disk and configured to block movement of the turbine blade relative to the multi-piece disk about the central axis.

2. The assembly of claim 1, wherein the anti-rotation feature includes a post that extends radially outward from the floor of the root channel that engages the root of the turbine blade to block movement of the turbine blade relative to the multi-piece disk about the central axis.

3. The assembly of claim 2, wherein the root of the turbine blade is shaped to define a post-receiver pocket into which at least a portion of the post extends.

4. The assembly of claim 3, wherein the post-receiver pocket extends circumferentially into a circumferential side of the root so as to provide a circumferentially-opening aperture that receives at least a portion of the post.

5. The assembly of claim 3, wherein the post-receiver pocket extends radially outwardly into a radially-inwardly facing side of the root between two circumferential sides of the root so as to provide a radially-inwardly-opening blind hole that receives at least a portion of the post.

6. The assembly of claim 2, wherein the anti-rotation feature further includes a mount pin that extends radially inwardly from the post into a pin-receiver hole formed in the floor of the root channel and a shoulder located at the interface of the anti-rotation feature and the floor of the root channel to block the anti-rotation feature from moving through the pin-receiver hole.

7. The assembly of claim 1, wherein the anti-rotation feature includes a post that extends radially inward from the root of the turbine blade into engagement with the floor of the root channel to block movement of the turbine blade relative to the multi-piece disk about the central axis.

8. The assembly of claim 7, wherein the post is integrally formed from ceramic matrix composite material along with the rest of the turbine blade so as to comprise a one-piece component.

9. The assembly of claim 7, wherein the floor of the root channel is formed to include a post-receiving pocket into which the post of the anti-rotation feature extends.

10. The assembly of claim 1, further comprising an independent platform located circumferentially adjacent to the turbine blade and configured to separate a gas path along the airfoil from the root of the turbine blade, the platform including an attachment portion arranged in the root channel that is shaped to block movement of the platform radially outwardly away from the multi-piece disk to couple the platform with the multi-piece disk and a gas path panel that faces a gas path extending across the airfoil of the turbine blade.

11. The assembly of claim 10, wherein the anti-rotation feature includes a post that extends radially inward from the attachment portion of the platform into engagement with the floor of the root channel to block movement of the platform relative to the multi-piece disk about the central axis such that the platform in turn blocks movement of the turbine blade relative to the multi-piece disk about the central axis.

12. The assembly of claim 11, wherein the post is integrally formed from ceramic matrix composite material along with the rest of the platform so as to comprise a one-piece component.

13. The assembly of claim 11, wherein the floor of the root channel is formed to include a post-receiving pocket into which the post of the anti-rotation feature extends.

14. A turbine wheel assembly adapted for rotation about a central axis, the assembly comprising
a disk shaped to provide a radially-outwardly opening root channel that forms a dovetail shape when viewed circumferentially around the central axis,
a turbine blade made of ceramic matrix composite materials, the turbine blade shaped to include a root with arranged in the root channel of the disk to couple the turbine blade to the disk and an airfoil arranged radially outward of the multi-piece disk, and
an anti-rotation feature arranged along a floor of the root channel of the disk, wherein the anti-rotation feature is configured to block movement of the turbine blade relative to the disk about the central axis.

15. The assembly of claim 14, wherein the anti-rotation feature includes a first post that extends radially outward from the floor of the root channel that engages the root of the turbine blade to block movement of the turbine blade relative to the multi-piece disk about the central axis.

16. The assembly of claim 15, wherein the root of the turbine blade is shaped to define a first post-receiver pocket into which at least a portion of the first post extends.

17. The assembly of claim 16, wherein the first post-receiver pocket extends circumferentially into a circumferential side of the root so as to provide a circumferentially-opening aperture that receives at least a portion of the first post.

18. The assembly of claim 16, wherein the first post-receiver pocket extends radially outwardly into a radially-inwardly facing side of the root between two circumferential sides of the root so as to provide a radially-inwardly-opening blind hole that receives at least a portion of the post.

19. The assembly of claim 16, wherein the root of the turbine blade is shaped to define a second pocket.

20. The assembly of claim 19, wherein the anti-rotation feature includes a second post that extends radially outward from the floor of the root channel that engages the root of the turbine blade to block movement of the turbine blade relative to the multi-piece disk about the central axis, and wherein at least a portion of the second post extends into the second pocket.
